(19) United States
(12) Patent Application Publication
(10) Pub. No.: US 2013/0128292 A1
(43) Pub. Date: May 23, 2013

(54) AREA BASED TEXT FORMATTING FOR PRINTERS

(71) Applicants: Staffan Gribel, Goteborg (SE); Peter Jonsson, Goteborg (SE)

(72) Inventors: Staffan Gribel, Goteborg (SE); Peter Jonsson, Goteborg (SE)

(21) Appl. No.: 13/810,849

(22) PCT Filed: Jul. 22, 2010
(86) PCT No.: PCT/JP2010/004702

§ 371 Date: Jan. 17, 2013

(51) Int. Cl. G06K 3/00; G06K 15/02

(52) U.S. Cl. CPC G06K 3/00
USPC 358/1.11

(57) ABSTRACT

A system and method for providing formatted content in a user-defined print area. In one or more embodiments, a database is stored on one or more processor readable media that are operatively coupled to one or more processors. A computing device associated with the one or more processors provides a user interface for defining at least one user-defined print area. The computing device provides one or more prompts for one or more parameters associated with the at least one user-defined print area. The one or more processors stores at least one of the one or more parameters received in response to at least one of the one or more prompts, and the one or more processors formats content provided in the user-defined print area in accordance with the at least one parameter of the one or more parameters. The formatted content is output by at least one printing device.

### TECHNICAL FIELD

The present invention relates generally to printers and, more particularly, to variable sized graphical objects.

### BACKGROUND ART

Label and ticket printers, including thermal printers, often use a legacy command set to communicate. For example, the Z-Level Programming Language (“ZPL”), Decision Programming Language (“DPL”) and System Programming Language (“SPL”) are employed for communicating instructions to label and ticket printers, including thermal printers. Command sets employed in these languages are text-based, as known in the art, and variables are typically defined such as for defining start of print coordinates, font types, point sizes and/or other characteristics of textual content that affect the appearance (e.g., shape and size) of lettering.

Languages that are used for controlling label and ticket printers typically require that various field properties, such as for print position, font type and point size, be set to ensure that the longest line or row of text does not extend beyond the width of the label. The largest point size that may be used for a particular font depends on the amount of text in each field. The ability to read a label or ticket may, therefore, depend on the length long the longest row of text within an available print area. For example, the width of an address label must be designed to support a complete street address or person's name. Often, a font having a small point size may be required, which negatively impacts the readability of content in such a label.

Relatively recently, software applications have been developed that provide graphical user interfaces and tools for custom label design and layout. Such applications enable designers to define label formats relatively easily, compared to older systems. Moreover, database integration tools are provided that enable data to be populated in one or more labels substantially automatically. In one known application, data may be provided in a label at the time of printing labels. An example of a software application providing label format and design is described in commonly assigned JP Patent Publication Serial Number 2003-191562, the entire contents of which are incorporated by reference in its entirety.

One feature of a known label design software application includes textbox objects that define placeholders for textual content to be provided in a label. Such textbox controls may automatically provide for word-wrap functionality, in which any text that exceeds a predefined line length automatically wraps to the next adjacent line. Forms of word-wrap include providing “soft” and/or “hard” line breaks, as known in the at, for text that is provided inside a textbox. The ability for text to wrap within a textbox enables a label designer to reduce the width (e.g., the horizontal extension) of a label, but height (e.g., the vertical extension) may be unknown.

In a known prior art application, a textbox control is provided that increases (or decreases) in size in response to the number of characters provided therein. During the design phase, a textbox control size selected by dragging a mouse or other pointing device over any one of four corners of the textbox control. When the pointing device is released, the textbox control is sized. Thereafter, as a user inputs a number of characters into the textbox control that exceeds the size of the textbox control, the textbox control may behave in various ways. For example, once the amount of text exceeds the size of the textbox, a new line is automatically started and the vertical height of the textbox control increases. In this example, the textbox size automatically increases. Although automatic resizing of a textbox to accommodate a varying amount of text may seem desirable, output from label and tag printers may be adversely affected thereby. For example, as a textbox size automatically increases, other content, such as a barcode or image, may get covered by the expanding textbox. Thus, the predefined label layout, which may appeared to be suitable to the designer, can be impractical.

Moreover, software applications do not well support word-wrap functionality in a thermal label or ticket printer. For example, a label may be restricted to a maximum vertical height, for example, due to its particular application, which could be exceeded due to a wrapped text in a variable textbox. Moreover, a textbox may have to be dimensioned to support a maximum width.

### CITATION LIST

### Patent Literature

PTL 1: JP Patent Publication 2003-191562

### SUMMARY OF INVENTION

### Technical Problem

The present invention has been made in view of the aforementioned shortcomings. Prior art label software applications define lines of text as a function of a specified number of characters, which results in text getting truncated if the point size is too large, or text that is rendered unreadable if the point size is too small.

The object of the present invention is to provide a user-defined print area, for example, in connection with output from a label and tag printer, that substantially automatically adjusts a respective font type, point size and/or other characteristics of textual content to accommodate the defined printable area.

Another object of the present invention is to provide label and tag printer design and development software application that includes one or more tools for the defined print area. Moreover, various types of fonts, including bitmap fonts that support horizontal and vertical magnification and scalable fonts are supported.

Another aspect of the invention is to provide a specified print area that includes user definable attributes that affect the behavior and appearance of textual content provided therein.

### Solution to Problem

In order to solve the aforementioned problem, the present invention focuses on providing a solution to the foregoing shortcomings.

A first aspect of the present invention includes a method for providing formatted content in a user-defined print area. A database is stored on one or more processor readable media that are operatively coupled to one or more processors. A computing device associated with the one or more processors provides a user interface for defining at least one user-defined print area. The computing device provides one or more prompts for one or more parameters associated with the at least one user-defined print area. The one or more processors store at least one of the one or more parameters received in response to at least one of the one or more prompts, and the one or more processors format content provided in the user-defined print area in accordance with the at least one parameter of the one or more parameters. The formatted content is output by at least one printing device.

A second aspect of the present invention relates to a system for providing formatted content in the user-defined print area. The system comprises one or more processor readable media, one or more processors operatively coupled to the one or more processor readable media, a database stored on the one or more processor readable media and a computing device associated with the one or more processors and the processor readable media. The computing device has instructions for causing the computing device to perform the following steps: providing a user interface for defining

at least one user-defined print area; and providing one or more prompts for one or more parameters associated with the at least one user-defined print area. The one or more processors further have instructions to perform the following steps: storing in the database at least one of the one or more parameters received in response to at least one of the one or more prompts; and formatting content provided in the user-defined print area in accordance with the at least one parameter of the one or more parameters. Further, a printing device is provided that is programmed and configured to output the formatted content.

A third aspect of the present invention relates to the at least one parameter of the one or more parameters defining one or more of field size, layout, data source and textual content.

A fourth aspect of the present invention relates to the at least one parameter defining at least a size of the user-defined print area.

A fifth aspect of the present invention relates to the content being formatted to fit within the user-defined print area.

A sixth aspect of the present invention relates to at least some of the content being formatted to fit within the user-defined print area and at least some of the content is not displayed in the user-defined print area. An indicator may be provided that the at least some of the content is not displayed.

A seventh aspect of the present invention relates to the at least one parameter of the one or more parameters defining that textual content provided in the user-defined print area wraps a predefined number of lines.

An eighth aspect of the present invention relates to the at least one parameter of the one or more parameters defining that a point size of the content provided in the user-defined print area is adjusted by the one or more processors for the content to fit within the user-defined print area.

A ninth aspect of the present invention relates to transferring, by the computing device, the database to at least one of the one or more processors that is associated with the printing device.

A tenth aspect of the present invention relates to the at least one of the one or more processors that formats the content provided in the user-defined print area being associated with the printing device.

An eleventh aspect of the present invention relates to adding the database to the printing device's application programming interface.

A twelfth aspect of the present invention relates to the printing device being a thermal printer.

A thirteenth aspect of the present invention relates to the one or more prompts being provided by at least one of the one or more processors that is associated with the printing device.

A fourteenth aspect of the present invention relates to the content being retrieved from an other database.

A fifteenth aspect of the present invention relates to the content being received from a keyboard operatively coupled to the printing device

### Advantageous Effects of Invention

A label provided with a relatively short line of text has better readability than a label provided with a relatively long line of text. This is at least partially due a small font point size required for a relatively long line of text.

Accordingly, a user-defined print area is provided in which textual or other content is variably sized to accommodate the size of the print area. By providing a label design that includes a specified print area instead of defining a data field, such as a textbox control, that requires a maximum number of characters, the readability of text in the specified print area is optimized. As shown and described in greater detail below, the specified print area is definable via one or more controls in an integrated label development software environment, which may contain a virtual toolbox of selectable controls.

### BRIEF DESCRIPTION OF DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates an example hardware arrangement, in accordance with a preferred embodiment;

FIG. 2 illustrates the functional elements of an example information processor shown in FIG. 1;

FIGS. 3A and 3B illustrate an example textbox control that is provided with different textual content, and that is variably sized to accommodate a user-defined print area in accordance with an embodiment;

FIG. 4 illustrates an example display screen that includes a graphical user interface for label designers to define a label format that includes a user-defined print area in accordance with an embodiment;

FIGS. 5A, 5B and 5C illustrate an example textbox control that includes a user-defined print area, and that is sized three different ways and provided with varying amounts of the same textual content;

FIG. 6 shows an example textbox control that has a parameter setting to enable the height of the textbox control to expand based upon a variable amount of textual content provided therein;

FIG. 7 illustrates an example textbox control wherein textual content provided therein contains no spaces;

FIG. 8 provides an example textbox control that illustrates textual content that is not fully displayed in a user-defined print area;

FIG. 9 illustrates an example textbox control that includes textual content that is not fully displayed, and that includes an indicator to alert a user or viewer thereof, in accordance with an embodiment;

FIG. 10 shows an example textbox control that includes an error message representing that textual content is not fully displayed due to a limitation in the size of the user-defined print area;

FIG. 11 illustrates an example textbox control that includes textual content that is not fully displayed in user-defined print area, and that does not include an indicator to alert a user thereof; and

FIG. 12 is another example of the embodiment shown in FIG. 11, wherein the Row setting parameter is set to prevent word-wrap and that includes textual content that is not fully displayed in the user-defined print area.

### DESCRIPTION OF EMBODIMENTS

In an embodiment, a specified print area includes user definable attributes that affect the behavior and appearance of textual content provided therein. For example, the height and width of the specified print area, and a content data source (e.g., a respective database) are defined and, thereafter, the font type, point size and/or other characteristics of textual content provided in the user-defined print area is substantially automatically adjusted to fit within the specified print area. Moreover, attributes can be defined that identify whether and when textual content should be truncated or otherwise not displayed in a specified print area. By selecting particular attributes in connection with the specified print area, label designers can be assured that virtually any textual content provided in the specified print area is supported in a desired manner and will be readable and/or aesthetically pleasing.

Each of the data elements in a label, such as generated by a thermal printer, may be displayed in one or more of a plurality of respective user-defined print areas defined in the label. Moreover, respective attributes for each of the user-defined print areas control the appearance and/or behavior of the specified print areas. Thus, and unlike prior art label definition software applications, the user-defined print area in accordance with the teachings herein can be provided in a number of places in a label. Thus, the user-defined print area provided in accordance with the teachings herein is an improvement over prior art single, global settings that affect the layout of all text entered in a label.

In addition to or in lieu of affecting the size of textual content that is provided within a user-defined print area, attributes may be defined to affect the height and width of the specified print area during or after textual content is provided therein. By defining size dimensions of the user-defined print area in addition to, or in lieu of, affecting the font type, point size and/or other characteristics of textual content, a powerful application is provided for label and tag printers.

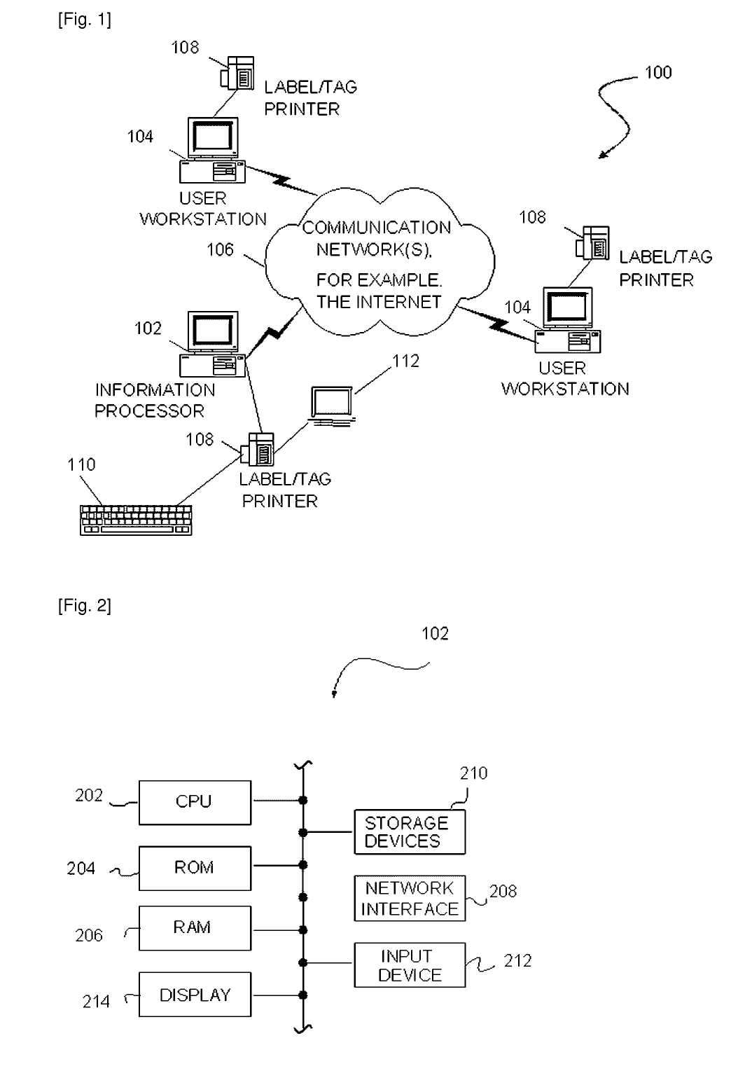

Referring now to the drawing figures, in which like reference numerals represent like elements, FIG. 1 illustrates an example hardware arrangement, in accordance with an embodiment of the present invention, for developing and providing a user-defined print area, including over a communication network, and referred herein, generally, as system 100. System 100 preferably comprises at least one information processor 102 (configured to operate as an Internet web server and/or database file server) programmed and configured to access communication network 106 and communicate with user workstation(s) 104. User workstations 104 and information processor(s) 102 may communicate via the known communications protocol, Transmission Control Protocol/Internet Protocol “TCP/IP.” In the example shown in FIG. 1, information processor(s) 102 are provided with an integrated development programming environment (“IDE”), such as to develop applications, as known to those skilled in the art. Information processor 102 preferably is provided with or has access to all databases necessary to support the present invention.

Information processor 102 may also be provided with printer firmware that is installed on printer 108. Printer 108 is preferably a label and tag printer, and may be a thermal printer or other type of printer. Moreover, information processor 102 and/or user workstation 104 may be provided with one or more software applications that are installable on printer 108 for custom configuration. Thus, in an embodiment, one or more software applications developed or otherwise provided (e.g., downloaded from the Internet) on information processor 102 and/or user workstation 104 is installed on printer 108. In this way, a software application containing features described herein is provided to printer 108, thereby configuring printer 108 with particular functionality.

Communication network 106 is preferably a global public communication network such as the Internet, but can also be a wide area network (WAN), local area network (LAN), an intranet or other network that enables computing devices and peripheral devices to communicate.

In a preferred embodiment, information processor 102 and user workstations 104 are any computer readable medium devices that are capable of sending and receiving data across communication network 106, e.g., mainframe computers, mini computers, personal computers, laptop computers, a personal digital assistants (PDA), cellular telephones and Internet access devices such as Web TV. In addition, information processors 102 are preferably equipped with web browser software, such as MICROSOFT INTERNET EXPLORER, MOZILLA FIREFOX, or the like. Information processors 102 are coupled to communication network 106 using any known data communication networking technology.

Also shown in FIG. 1 is printer 108 that is preferably a label and tag printer and operable to print labels and tags of data received from information processors 102. Label and tag printer 108 may be provided with keyboard and display to enable input and output functionality with label and tag printer 108 in addition to or in the absence of or in conjunction with information processor 102. A keyboard API (not shown) is preferably provided that is operable to receive and interpret (i.e., read) signals from keyboard 110 that may be integrated with label and tag printer 108. The keyboard API may be operable to read and interpret signals from an external keyboard or other input device not directly coupled to label and tag printer 108. Moreover, a display API may be provide that operates to present a variety of textual and graphical content to display 112 integrated with printer 108. Alternatively, the display API may be operable to write textual and graphical content to an external display attached to label and tag printer 108. Preferably, the display API supports a wide selection of fonts and coding types, for example, for many different written languages.

FIG. 2 illustrates the functional elements of an example information processor 102 and/or user workstation 104, and includes one or more central processing units (CPU) 202 used to execute software code and control the operation of information processor 102. Other elements include read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code databases and application data, one or more input devices 212 such as a keyboard, mouse, track ball, microphone and the like, and a display 214. Further, one or more of functional elements 202-214 may be suitably configured or provided with label and tag printer 108, as well.

The various components of information processor 102 and/or workstation 104 need not be physically contained within the same chassis or even located in a single location. For example, storage device 210 may be located at a site which is remote from the remaining elements of information processor 102, and may even be connected to CPU 202 across communication network 106 via network interface 208. Information processor 102 and/or user workstation 104 preferably includes a memory equipped with sufficient storage to provide the necessary databases, forums, and other community services as well as acting as a web server for communicating hypertext markup language (HTML), Java applets, Active-X control programs. Information processors 102 and/or user workstation 104 are arranged with components, for example, those shown in FIG. 2, suitable for the expected operating environment. The CPU(s) 202, network interface(s) 208 and memory and storage devices are selected to ensure that capacities are arranged to accommodate expected demand.

The nature of the invention is such that one skilled in the art of writing computer executable code (i.e., software) can implement the functions described herein using one or more of a combination of popular computer programming languages and developing environments including, but not limited to, LUA, C, C++, Visual Basic, JAVA, HTML, XML, ACTIVE SERVER PAGES, JAVA server pages, servlets, MYSQL and PHP.

Although the present application is described by way of example herein and in terms of a web-based system using web browsers and a web site server (e.g., information processor 102), system 100 is not limited to such a configuration. It is contemplated that system 100 is arranged such that label and tag printer 108 communicates with and outputs data received from information processor 102 and/or user workstation 104 using any known communication method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 102, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

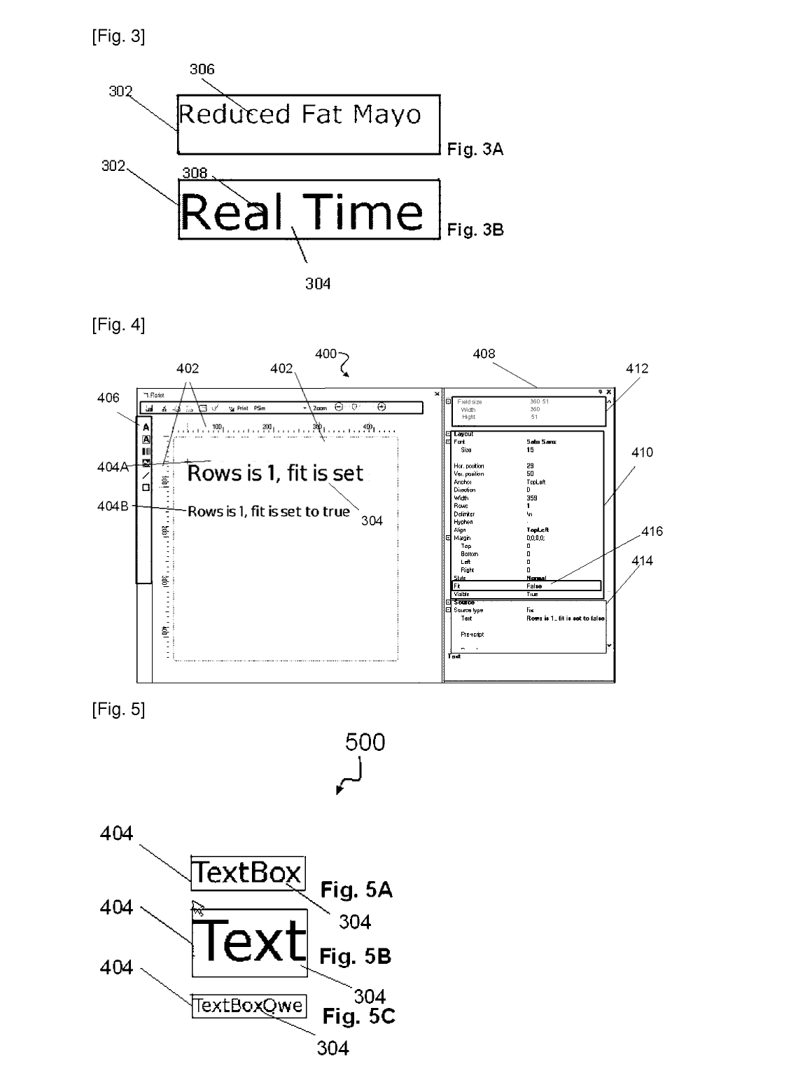

In accordance with an embodiment, user-defined parameters are provided to control the appearance and/or behavior of textual content provided in a user-defined print area. FIGS. 3A and 3B illustrate one example textbox control 302 that is provided with different textual content, and that is variably sized to accommodate the user-defined print area 304 of textbox control 302 in accordance with an example embodiment. In FIG. 3A, textbox control 302 is provided with the value, “Reduced Fat Mayo” that is formatted with a first point size 306. FIG. 3B illustrates textbox control 302 provided with the value, “Real Time” and that is formatted with a second, point size 308 that is larger than point size 306. Thus and as illustrated in FIGS. 3A and 3B, textbox control 302 is formatted a single user-defined print area 304, and text values provided therein are automatically formatted with respective point sizes 306, 308 to accommodate the user-defined print area 304. As shown and described in greater detail below in connection with FIG. 4, the point size is automatically adjusted to the user-defined print area 304 when the value for the attribute “FIT” is set to TRUE.

FIG. 4 illustrates an example display screen 400 that includes a graphical user interface for label designers to define a label format that includes a user-defined print area in accordance with the teachings herein. As shown in the example label layout section 402, two textbox controls (404A and 404B) are shown that have respective user-defined print areas 304, with textbox control 404A being selected and having the focus, as known in the art. Other controls are provided in virtual toolbox section 406 for a user to insert, for example, text, data fields, bar codes, graphics, lines and/or boxes within label layout section 402. Control parameters section 408 is provided to define options (e.g., parameters) for controls selected from virtual toolbox section 406. In the example shown in FIG. 4, textbox control 404A is selected and, accordingly, the respective parameter options provided in layout section 410 apply for user-defined print area 304 provided therein exclusively. After textbox control 404B is selected (and receives the focus), the parameters shown in layout section 410 apply for textbox control 404B, exclusively.

Continuing with reference to FIG. 4, control parameters section 408 includes options for defining field properties (section 412), layout (section 410) and defining data source(s) (section 414). Of course, one skilled in the art will recognize that the layout and appearance of control parameters section 408, as well as the respective options provided therein, can be provided in many other ways, and that the particular configuration and appearance shown in FIG. 4 represents one example. Options provided in field properties section 412 include, for example, defining an overall size for a data field, and for defining a respective field height and width. Measurement units may be selected as well, such as for pixels, inches, centimeters, or other suitable unit of measurement (not shown). Layout section 410 includes a plurality of parameter values for affecting the appearance and behavior of content provided within a user-defined print area 304. Options include, for example, Font Type, Point Size, Font Filename (e.g., location where a respective font is stored), Horizontal Position, Vertical Position, Anchor (e.g., where text begins), Direction (e.g., which direction text is displayed), Width (e.g., the width of the user-defined print area 304), Rows (e.g., the number of rows that textual content is entitled to wrap), Delimiter (e.g., a data value representing an end of line or data separation), Hyphen (e.g., optional value to display when words and/or lines are wrapped or broken), Alignment, Margin values including Top, Bottom, Right and Left (e.g., within the user-defined print area 304), Style (e.g., for displaying content in particular ways), Fit 416 (e.g., to enable automatic resizing of textual content to fit within specified user-defined print area parameters, and Visible (e.g., whether content within user-defined print area 304 is displayed).

In an embodiment, when the Rows parameter in section 410 is set to 0, textual content provided in user-defined print area 304 wraps to as many lines as are required for the complete textual content to be displayed using the selected font type, point size and width values selected in section 410. Although those respective values will not be affected, the height of user-defined print area 304 automatically adjusts to accommodate the textual content. Alternatively, if the value for Rows is set to any value greater than zero (>0), then textual content within print area 304 will wrap only a maximum of that defined number of rows. If the amount of textual content, formatted in accordance with options in section 410, exceeds the number of lines defined in the Rows then not all of the textual will be displayed or printed. Moreover, if the value in the Rows parameter is set to 1, then textual content will not wrap at all. In accordance with an embodiment, the Fit parameter 416 can be set to a value of “TRUE” and cause textual content within user-defined print area 304 to be automatically sized and attempted to fit within the user-defined print area, in accordance with the teachings herein.

FIGS. 5A, 5B and 5C illustrate an example textbox control 404 that includes a user-defined print area 304, and that is sized three different ways and provided with varying amounts of the same textual content. FIGS. 5A-5C illustrate how textual content provided in user-defined print area 304 behaves and appears differently in accordance with parameter settings, such as provided in control parameters section 408 (FIG. 4). In the examples shown in FIGS. 5A-5C, a scalable font type, such as TRUETYPE font, is shown. In each of FIGS. 5A-5C, the amount of textual content that is displayed is restricted to the font and size of the characters and the size of the user-defined print area 304 for the respective textbox controls 404.

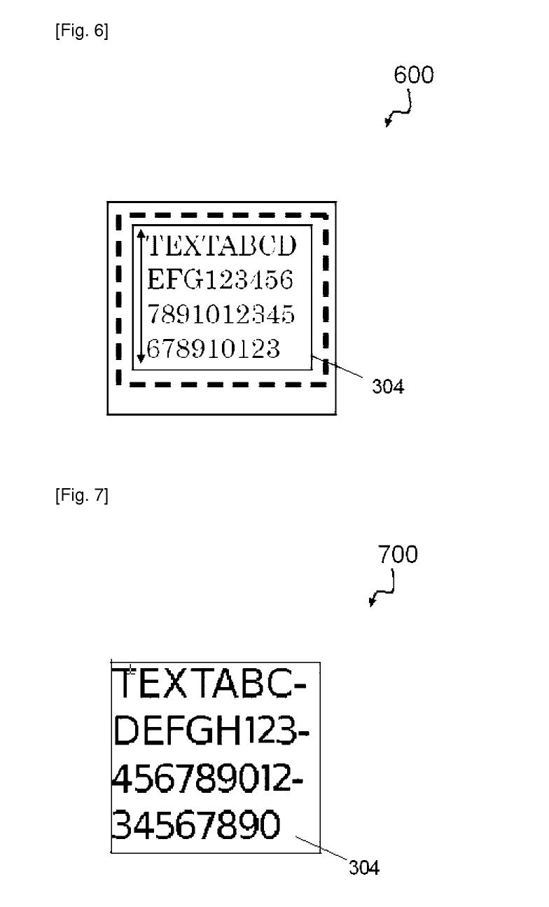

FIG. 6 illustrates an example textbox control 600 that has a Row setting parameter set to the value 0, which enables the height of the textbox control to expand based upon a variable amount of textual content provided therein. The example shown in FIG. 6 demonstrates that the box height of control 600 increases as a user continues to type or otherwise enter textual content therein. The behavior of control 600, based upon a parameter setting such as provided in control parameters section 408 (FIG. 4), is to expand in height to accommodate characters that a user enters or for characters otherwise provided therein.

FIG. 7 illustrates an example textbox control 700 wherein textual content entered by the user contains no spaces. In the example shown in FIG. 7, hyphens have been automatically inserted in textbox control 700, in accordance with the hyphen parameter setting defined in control parameters section 408 (FIG. 4).

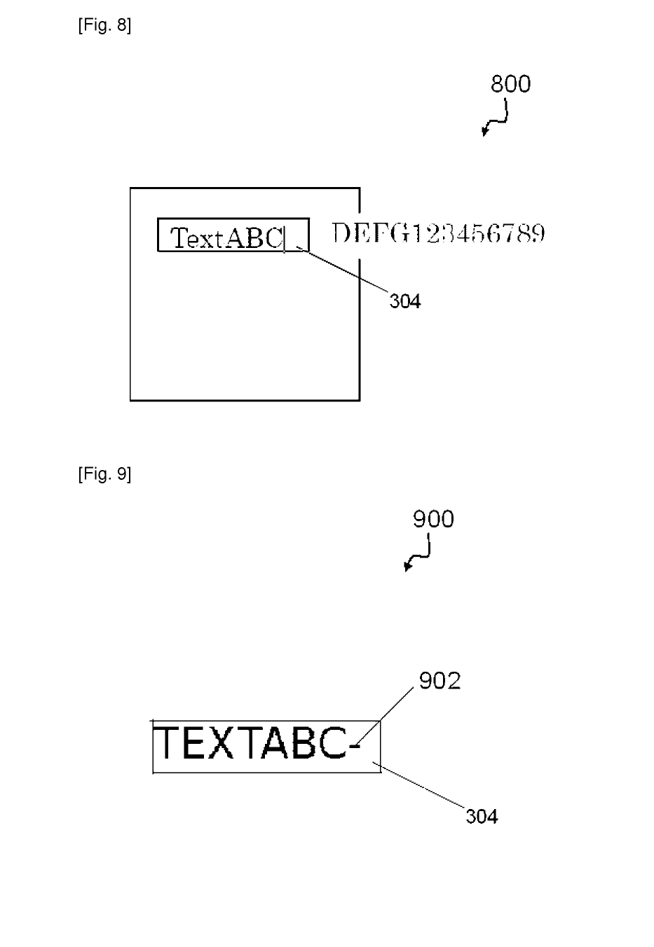

FIG. 8 illustrates an example textbox control 800 that illustrates textual content that is not fully displayed in user-defined print area 304 due to limitations set, for example, in control parameters section 408 (FIG. 4). In the example shown in FIG. 8, the Row setting parameter is set to the value 1, which precludes the user-defined print area 304 in textbox control 800 from wrapping beyond one line. Moreover, Fit 416 parameter setting is set to FALSE, which precludes the size of the textual content from being adjusted to accommodate the user-defined print area 304. Accordingly, any characters that are provided in textbox control 800 that exceed the width of the user-defined print area 304 will not be displayed. In the example shown in FIG. 8 and to demonstrate this feature, the characters in textbox control 800 are displayed, and the characters outside of textbox control 800 are not displayed.

In a preferred embodiment, if the total amount of textual content cannot be displayed in user-defined print area 304, then some indicator is provided to alert the user and/or viewer thereof. FIG. 9 illustrates an example textbox control 900 that includes textual content that is not fully displayed in user-defined print area 304, and that includes an indicator 902 to alert a user or viewer thereof. In the example shown in FIG. 9, a hyphen is the selected indicator 902. Preferably, the last line (regardless of the number of lines) of any textual content provided with an indicator 902 represents that some textual content exists that was not displayed.

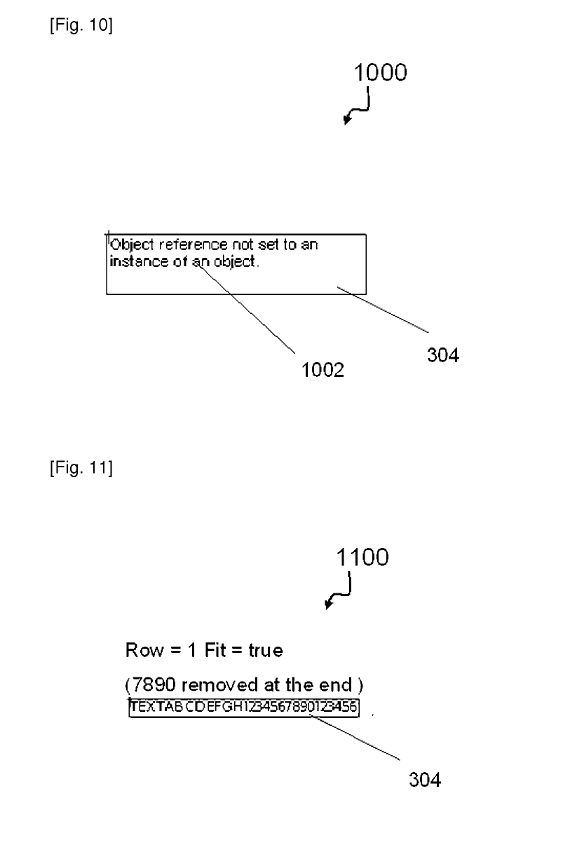

As noted above, a user can define that Fit 416 parameter (FIG. 4) be defined to the value TRUE, which affects, for example, the point size and/or the font type of the textual content so that the textual content is accommodated by user-defined print area 304. In some cases, however, there is too much textual content to be supported by user-defined print area 304 and for the textual content to be readable. In such case, an error code and/or message is preferably displayed in user-defined print area 304 to indicate that textual content is not displayed. FIG. 10 illustrates an example textbox control 1000 that includes an error message 1002 representing that textual content is not fully displayed due to a limitation in the size of the user-defined print area. In the example shown in FIG. 10, the Row setting parameter is set to the value 1 (i.e., no word-wrap is enabled) and the Fit 416 parameter (FIG. 4) is set to TRUE. In the example shown in FIG. 10, the point size for textual content cannot be decreased to accommodate the print area 304 and maintain readability. Accordingly, error message 1002 is displayed.

In one embodiment, a designer or other user may prefer that no indicator 902 is displayed in case some amount of textual content is not displayed, particularly if the Fit 416 parameter (FIG. 4) is set to TRUE. Even if some content is not displayed, the designer or other user may prefer that the text displayed in user-defined print area 304 is truncated. FIG. 11 illustrates an example textbox control 1100 that includes textual content that is not fully displayed in user-defined print area 304, and that does not include an indicator 902 (FIG. 9) to alert a user or viewer thereof. In the example shown in FIG. 11, the Row setting parameter is set to the value 1 (i.e., no word-wrap is enabled) and the Fit 416 parameter (FIG. 4) is set to TRUE.

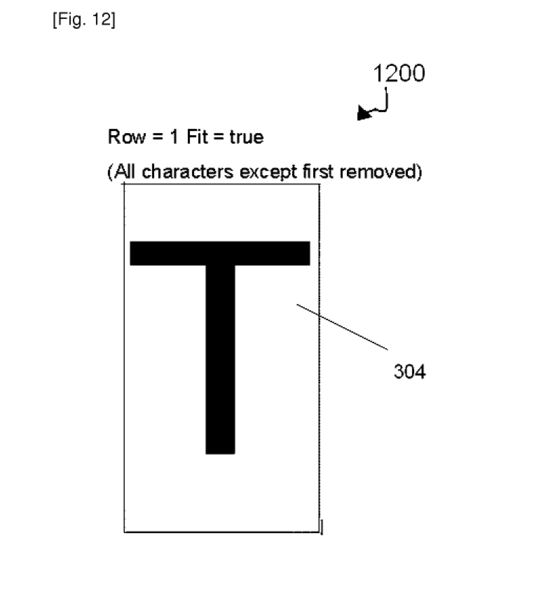

FIG. 12 is another example of the embodiment shown in FIG. 11, wherein the Row setting parameter is set to the value 1 (i.e., no word-wrap is enabled) and the Fit 416 parameter (FIG. 4) is set to TRUE. Due to the large user-defined print area 304 that is provided, only the first character (“T”) is displayable in example textbox control 1200. Thus, and as illustrated in FIGS. 11 and 12, the size of user-defined print area 304 and textbox control 1100, 1200 are not affected by the amount of textual content provided, therein. Instead, the appearance of the textual content modifies to accommodate the user-defined print area 304.

Thus, in accordance with preferred embodiments, a user-defined print area is definable enables label or other designers to establish a label, tag or other printed output that has a predefined dimensions including a fixed width, a variable or fixed height that substantially automatically formats textual content provided therein to accommodate the predefined dimensions. By providing such functionality in printers, particularly thermal printers, a fundamental improvement over prior art label and tag printer applications is provided in accordance with the teachings herein.

Moreover, and as described above in connection FIG. 1, in an embodiment one or more software applications provided in accordance with the teachings herein or otherwise supporting one or more features described herein is installed on printer 108

Although the present invention is described and shown in relation to particular embodiments thereof, many other variations and modifications and other uses will become apparent to those skilled in the art. It is preferred, therefore, that the present invention be limited not by the specific disclosure herein.

1-32. (canceled)

33. A method for providing formatted content in a user-defined print area, the method comprising:
storing, on one or more processor readable media that are operatively coupled to one or more processors, at least one database;
providing, by a computing device associated with the one or more processors and the processor readable media, a user interface for defining at least one user-defined print area;
providing, by the computing device or the one or more processors, one or more prompts for one or more parameters associated with the at least one user-defined print area;
storing, by the computing device or the one more processors, at least one of the one or more parameters received in response to at least one of the one or more prompts;
formatting, by the computing device or the one or more processors, content provided in the user-defined print area in accordance with the at least one parameter of the one or more parameters; and
outputting the formatted content by at least one printing device.

34. The method of claim 33, wherein the at least one parameter of the one or more parameters defines one or more of field size, layout, data source and textual content.

35. The method of claim 33, wherein the at least one parameter of the one or more parameters defines at least a size of the user-defined print area.

36. The method of claim 35, wherein all of the content is formatted to fit within the user-defined print area.

37. The method of claim 35, wherein at least some of the content is formatted to fit within the user-defined print area and at least some of the content is not displayed in the user-defined print area.

38. The method of claim 37, further comprising formatting, by the one or more processors, the content to include an indicator that the at least some of the content is not displayed.

39. The method of claim 33, wherein the at least one parameter of the one or more parameters defines that the size of the user-defined print area is fixed.

40. The method of claim 33, wherein the at least one parameter of the one or more parameters defines that textual content provided in the user-defined print area wraps a predefined number of lines.

41. The method of claim 33, wherein the at least one parameter of the one or more parameters defines that a point size of the content provided in the user-defined print area is adjusted by the one or more processors for the content to fit within the user-defined print area.

42. The method of claim 33, further comprising transferring, by the computing device, the database to at least one of the one or more processors that is associated with the at least one printing device.

43. The method of claim 42, wherein the at least one of the one or more processors that formats the content provided in the user-defined print area is associated with the at least one printing device.

44. The method of claim 33, further comprising adding the database to the at least one printing device's application programming interface.

45. The method of claim 33, wherein the at least one printing device is a thermal printer.

46. The method of claim 33, wherein the one or more prompts is provided by at least one of the one or more processors that is associated with the at least one printing device.

47. The method of claim 33, wherein the content is retrieved from an other database.

48. The method of claim 33, wherein the content is received from a keyboard operatively coupled to the at least one printing device.

49. A system for providing formatted content in the user-defined print area, the system comprising:
one or more processor readable media;
one or more processors operatively coupled to the one or more processor readable media;
a database stored on the one or more processor readable media;
a computing device associated with the one or more processors and the processor readable media, the computing device having instructions for causing the computing device to perform the following steps:
providing a user interface for defining at least one user-defined print area;
providing one or more prompts for one or more parameters associated with the at least one user-defined print area;
wherein the one or more processors further have instructions to perform the following steps:
storing in the database at least one of the one or more parameters received in response to at least one of the one or more prompts;
formatting content provided in the user-defined print area in accordance with the at least one parameter of the one or more parameters; and
at least one printing device programmed and configured to output the formatted content.

50. The system of claim 49, wherein the at least one parameter of the one or more parameters defines one or more of field size, layout, data source and textual content.

51. The system of claim 49, wherein the at least one parameter of the one or more parameters defines at least a size of the user-defined print area.

52. The system of claim 51, wherein all of the content is formatted to fit within the user-defined print area.

53. The system of claim 51, wherein at least some of the content is formatted to fit within the user-defined print area and at least some of the content is not displayed in the user-defined print area.

54. The system of claim 53, further comprising formatting, by the one or more processors, the content to include an indicator that the at least some of the content is not displayed.

55. The system of claim 49, wherein the at least one parameter of the one or more parameters defines that the size of the user-defined print area is fixed.

56. The system of claim 49, wherein the at least one parameter of the one or more parameters defines that textual content provided in the user-defined print area wraps a predefined number of lines.

57. The system of claim 49, wherein the at least one parameter of the one or more parameters defines that a point size of the content provided in the user-defined print area is adjusted by the one or more processors for the content to fit within the user-defined print area.

58. The system of claim 49, wherein the computing device is further programmed and configured to transfer the database to at least one of the one or more processors that is associated with the at least one printing device.

59. The system of claim 58, wherein the one or more processors that format the content provided in the user-defined print area is associated with the at least one printing device.

60. The system of claim 49, wherein the computing device is further programmed and configured to add the database to the at least one printing device's application programming interface.

61. The system of claim 49, wherein the at least one printing device is a thermal printer.

62. The system of claim 49, wherein the one or more prompts is provided by at least one of the one or more processors that is associated with the at least one printing device.

63. The system of claim 49, further comprising an other database from which the content is retrieved.

64. The system of claim 49, further comprising a keyboard operatively coupled to the at least one printing device from which the content is received.
